(19) United States
(12) Patent Application Publication
(10) Pub. No.: US 2010/0306157 A1
(43) Pub. Date: Dec. 2, 2010

(54) Method and computer implemented system for social decision making

(75) Inventors: Ivan Onuchin, Hollywood, FL (US); Sergey Gurin, Hollywood, FL (US); Vlatcheslav Reshetnyak, Hollywood, FL (US); Alexey Moshkov, Boynton Beach, FL (US); Pavel Gurin, Chicago, IL (US); Ganna Mikheleva, Hallandale, FL (US)

Correspondence Address: Helpful Technologies, Inc, PO Box 220830, Hollywood, FL, 33022, US

(73) Assignee: Helpful Technologies, Inc., Hollywood, FL (US)

(21) Appl. No.: 12/800,877

(22) Filed: May 25, 2010

Related U.S. Application Data
(60) Provisional application No. 61/216,855, filed on May 26, 2009.

(51) Int. Cl. G06N 5/02

(52) U.S. Cl. 706/50

(57) ABSTRACT

The method and computer implemented system for social decision making is disclosed. The method commences with a decision maker working interactively with a computer system via the Internet. Decision maker identifies a topic for discussion and the initial pros and cons factors pertinent to a topic; each pro and con factor is attributed by a set of values and criteria. Decision maker then uses a set of social collaboration tools to gather opinions of the others. The others agree or disagree with a set of values and criteria attributed to initial cons and pros. The others can also submit their opinions in a form of the pros and cons pertinent to a topic each attributed by a set of values and criteria. The data is being stored in a machine readable format on a facilitator's server. A computing algorithm then calculates the sets of values, prioritizes criteria, and analyzes the data. Upon completion, a computer system transmits a visualization of data from a facilitator's server to a user computer displaying information in a format that allows a user to use emotional intelligence to make a conclusive decision.

### CROSS-REFERENCE TO RELATED APPLICATIONS

This application claims priority from U.S. provisional application No. 61/216,855 filed May 26, 2009 the details of which are incorporated herein by reference.

### FIELD OF INVENTION

The subject of invention is directed to a decision process, and namely to using a social collaboration in conjunction to a proprietary algorithm to gather and present pros and cons in visual format to trigger the emotional intelligence of a decision maker in order to conclude a decision.

### BACKGROUND OF THE INVENTION

The invention relates to systems, methods, and instruments of human interaction with purpose of making a decision. In order to make a decision, people are accustomed to gathering opinions from other people and analyzing such opinions in order to conclude a decision. There is a significant amount of work related to a decision making process.

Conventional methods of computer-based decision making feature several problems. For example: the Analytic Hierarchy Process (AHP) is a widely used method of decision making. The AHP method is based upon a computer-implemented prioritizing of criteria and generating suggestions by forecasting results, whereas a decision hierarchy can be achieved by converting pros and cons into objectives. One of the problems is substitution of a human interaction with computer-implemented suggestion mechanisms, whereas a computer calculates the relative value scores without tailoring it to particular user objectives. The substitution of a human intervention causes the consistently inaccurate results and leads to derivative errors, among which are (for example) is the inaccurate value scores for pros and cons, which later affect a quality of a forecast.

This invention is designed to enable a computer-implemented collection, analysis, and presentation of the individual or group judgments to use human emotional intelligence for assessing a value of opinions for a decision making.

With the expansion of a network, people use social networking to share and receive information through a computer network. The social networking provides communication tools, but fails to leverage the power of the group judgment for a decision making.

This invention is designed to utilize human interaction to simplify a decision making by using a social collaboration and a set of tools provided in electronic format.

The invention is also aimed at solving other shortcomings of the related art.

### CITED REFERENCES

U.S. Pat. No. 5,312,114 Apparatus and method for enhancing decision-making
U.S. Pat. No. 5,321,833 Adaptive ranking system for information retrieval
U.S. Pat. No. 5,566,291 Method and apparatus for implementing user feedback
U.S. Pat. No. 5,799,298 Method of indirect specification of user preferences
U.S. Pat. No. 5,847,708 Method and apparatus for sorting information
U.S. Pat. No. 5,933,145 Method and system for visually indicating a selection query
U.S. Pat. No. 5,995,728 Computer implemented method of generating and displaying objectives from pros and cons for evaluating decision alternatives
U.S. Pat. No. 6,850,891 Method and system of converting data and judgements to values or priorities
U.S. Pat. No. 5,312,114 Apparatus and method for enhancing decision-making
U.S. Pat. No. 7,080,071 Automated decision advisor
U.S. Pat. No. 5,566,291 Method and apparatus for implementing user feedback
Ser. No. 12/020,653 Method and Device for Providing a Personal Product Recommendation
Ser. No. 11/514,429 Enhanced user reviews
U.S. Pat. No. 6,377,944 Web response unit including computer network based communication
U.S. Pat. No. 6,829,603 System, method and program product for interactive natural dialog
Ser. No. 11/419,808 Social information system

### BRIEF SUMMARY OF THE INVENTION

The invention provides a computer-implemented method of organizing a platform for social decision making that are accessible with an application running on a computer.

The method includes the step of providing a user interface application which may run on a client computer, a mobile electronic device, or/and be embedded into any website.

The method also includes the step of maintaining the user generated database.

The method further includes provision of data entry mechanisms. The data entry mechanisms are displayed within the user interface application. The data entry mechanisms are selectable by a user. The data entry mechanisms enable a user to submit key factors into the user generated database.

The method further includes provision of communication tools. The communication tools are displayed within the user interface application. The communication tools are selectable by a user. The communication tools enable a user to engage other people into a decision making process. The communication tools also enable other people to submit the additional key factors into a user generated database.

The method further includes provision of decision making tools. The decision making tools are displayed within the user interface application. The decision making tools are selectable by a user. The decision making tools enable a user to assign levels of priority to the key factors submitted into the user generated database. The key factors may be edited or deleted by a user. The decision making tools also enable a user to assign values to the key factors submitted into the user generated database. The values may be edited or deleted by a user. The decision making tools also enable users to visualize the priorities and the values for the key factors submitted into the user generated database.

The invention also provides a system for organizing and maintaining an access to the decision making tools. The system includes a server computer maintaining a database of user generated data. The system also includes a client computer having a display and an input mechanism. The client computer is in communication with the server computer. The client computer is also capable of running a web browser application and a user interface application. The user interface application displays the data entry fields that are selectable by a user, then receives and records data into the user generated database, and then displays data to a user for use with the decision making tools that are also selectable by a user.

The invention also includes a computer program product for organizing and accessing the decision making tools. The computer program product includes computer readable program code means for provision of the decision making tools to users. The computer readable program code also means display of decision making tools independently from the web browser application.

By utilizing the method, system, and computer program product of the present invention, a user may utilize the social networking tools for a decision making process. This is advantageous for many individuals and organizations in order to make a more informed decision.

### BRIEF DESCRIPTION OF THE DRAWINGS

FIG. 1 illustrates a conceptual view of a preferred embodiment.

FIG. 2 illustrates a process of gathering opinions on the subject topic.

FIG. 3 illustrates a delivery diagram to value an opinion.

FIG. 4 illustrates a process of assessment of values in a preferred computer-implemented system.

FIG. 5 illustrates capturing data on topics, applying the assessment of values of the topics, and delivering a visual presentation to a decision maker.

FIG. 6 illustrates a synthesis of a preferred computer process and system for social decision making.

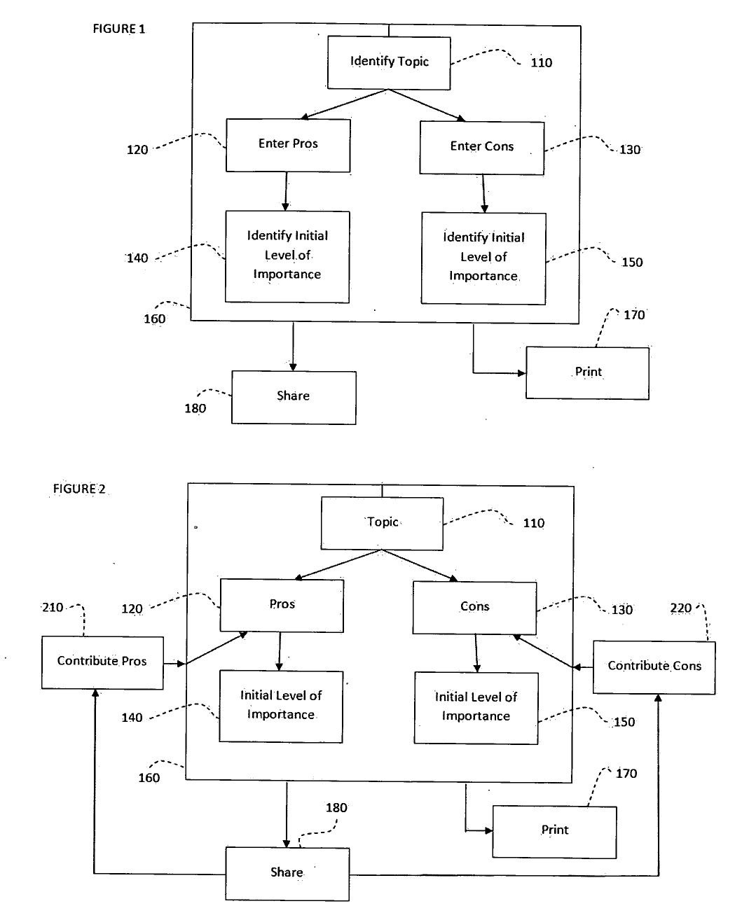

### DETAILED DESCRIPTION OF THE PREFERRED EMBODIMENT

A preferred embodiment of this invention comprises a series of processes that, when implemented as a system, create an application that enables a decision maker to visualize the values of opinions on a topic.

For a construction of preferred embodiment (Box 160), a decision maker identifies a topic (Box 110) and enters initial pros (Box 120) and cons (Box 130) attributes for the topic. The pros and cons can be displayed within a preferred embodiment in a concise or detailed manner at a preference of a decision maker.

Box 140 and Box 150 represent a process of collecting the initial value of importance level attribute to the pros and cons. This is done by using a graphical interface to record a numeric ratio of an initial level of importance with a facilitator's server.

A decision maker can print a preferred embodiment for his/her own use (Box 170) and share the preferred embodiment with the others (Box 180) at his/her discretion.

FIG. 2 presents a process of gathering opinions from the others (Step 2) and recording such opinions within the preferred embodiments using the facilitator's server. A recipient of shared information (Box 180) can submit the consecutive pros (Box 210) or cons (Box 220) attributable to a topic (Box 110). Upon submission of such pros and cons from a consecutive user, a preferred system requests a consecutive user submission of the initial value of importance level attribute to the pros and cons submitted, after which a consecutive user can print a preferred embodiment for his/her own use (Box 170) and share the preferred embodiment with the others (Box 180) at his/her discretion.

FIG. 3 depicts the essential information flows that take place independently from Step 2. A consecutive user can provide a value of opinion on the pros (Box 310) and cons (Box 320) attributes to a subject topic, which is recorded in numeric ratio format with the facilitator's server.

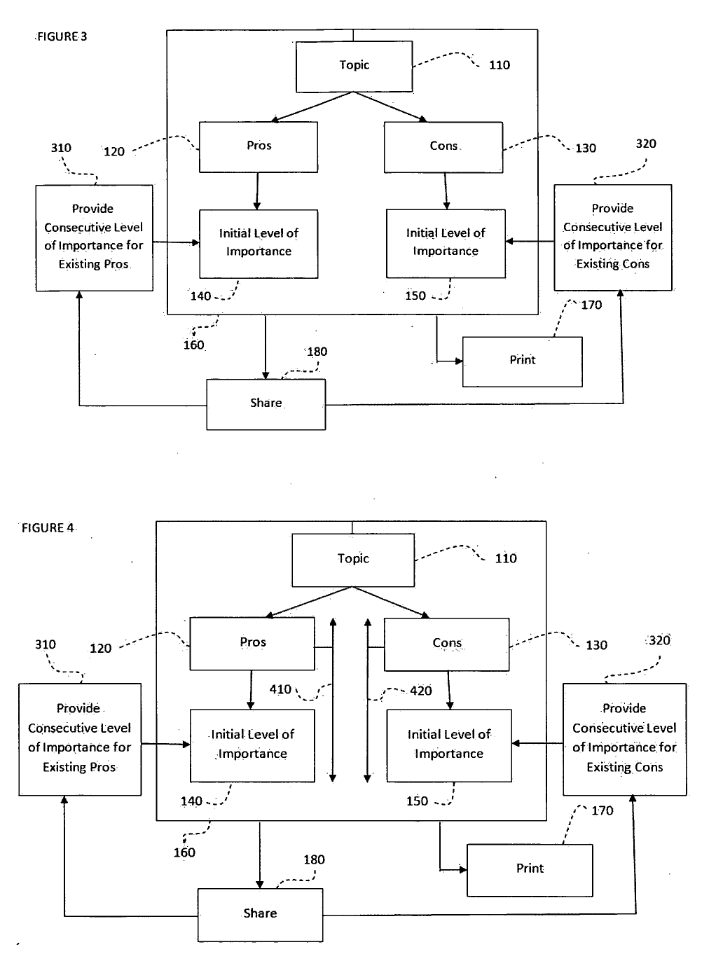

Submission of consecutive users' opinions (FIG. 2) and value ratios on the pros and cons (FIG. 3) activates a computing analytics and comparison algorithm (FIG. 4). The algorithm calculates the sets of values, prioritizes criteria, and analyzes the information submitted by users. Consecutively, a computer system transmits a visualization of findings from a facilitator's server to a user computer prioritizing the pros and cons relevant to their respective aggregate values (Box 410 and Box 420) and displaying information in a format that allows a user to use emotional intelligence to make a conclusive decision.

The algorithm further attributes the respective aggregate ratios to topics (FIG. 5). A preferred embodiment further comprises the comparison of topics (Boxes 510, 520, and 530) function (Box 550) transmitted from the facilitator's server to a decision maker computer (Box 540).

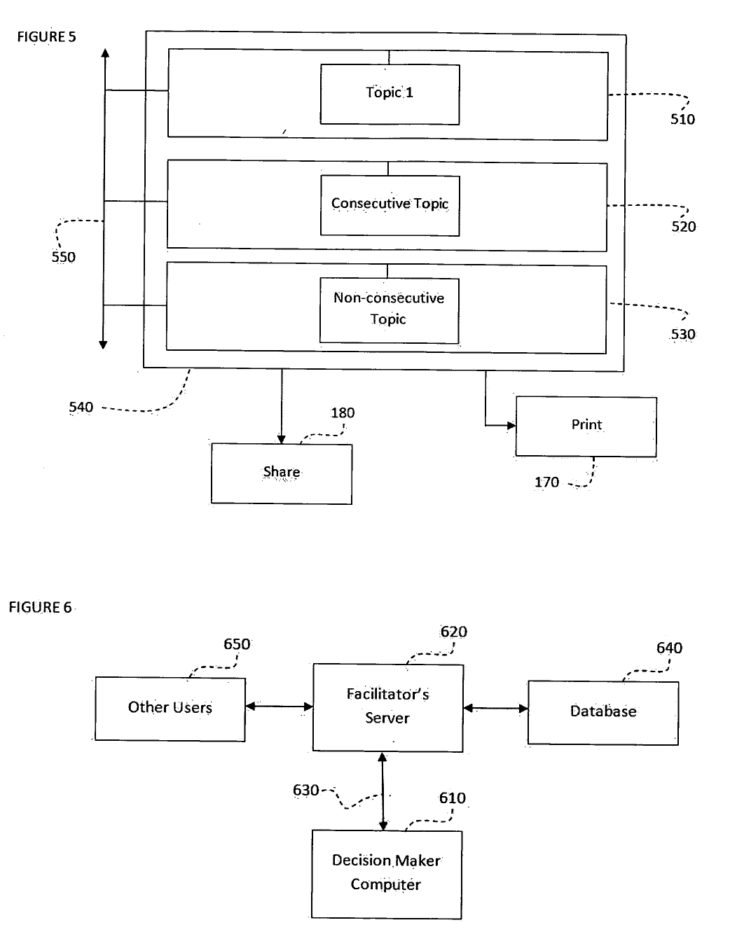

FIG. 6 illustrates a synthesis of a preferred computer process and system for social decision making and data flows among a decision maker computer (Box 610), the facilitator's server (Box 620), a machine readable database (Box 640), other users' computer (Box 650) via the network connection (Box 630).

What claimed is:

1. A method of social decision making that involves an Internet data transmission, a user, a facilitator, a topic, a set of cons and pros data, a set of topic importance data, a set of social collaboration tools, a respondent (one or more), a set of response gathering tools, a response data, a set of analytical tools, an analysis data, an algorithm to analyze data values and criteria, and a visualization of an analysis data. The method comprises the following:
1.1. Receiving a topic definition entry from a user to a facilitator's server;
1.2. Storing a topic data on facilitator's server;
1.3. Receiving a definition of initial cons and pros pertinent to a topic from a user to a facilitator's server;
1.4. Storing a definition of initial cons and pros pertinent to a topic on a facilitator's server;
1.5. Receiving an initial importance assessment value pertinent to a topic from a user to a facilitator's server;
1.6. Storing an initial importance assessment value pertinent to a topic on a facilitator's server;
1.7. Communicating a topic from a user to a respondent via an Internet source;
1.8. Storing a communication on facilitator's server;
1.9. Gathering a response, including but not limited to a set of consecutive importance assessment value pertinent to a topic, from a respondent to a facilitator's server;
1.10. Storing a response, including but not limited to a set of consecutive importance assessment value pertinent to a topic, on a facilitator's server;
1.11. Transmitting a response, including but not limited to a set of consecutive importance assessment value and criteria pertinent to a topic, to a user;
1.12. Aggregating all the pros and the cons pertinent to a topic into an analyzable format;
1.13. Providing a user with a set of analytical tools to produce an analysis data;
1.14. Storing an analysis data on a facilitator's server;
1.15. Using an algorithm that computes usage and analysis data;
1.16. Converting an analysis data into a user-friendly format;
1.17. Displaying information to a user in a user-friendly format to simplify a decision making.

2. A computer system of social collaboration that presents the method to a user via an Internet connection, stores and transmits information to/from a user, and provides a user with interactive tools for evaluating information. The system comprises the following:
2.1 A recording medium readable by the computer system;
2.2 At least one initial entry data related to a topic, the plurality of consecutive data entries, and the plurality of users;
2.3 Means for receiving information from a user;
2.4 Means for storing information on a recording medium;
2.5 Means for displaying information to a user;
2.6 An algorithm computing data values;
2.7 A central computer server communicating with the at least one user computer;
